(19) United States
(12) Patent Application Publication
(10) Pub. No.: US 2006/0051697 A1
(43) Pub. Date: Mar. 9, 2006

(54) Process for manufacturing organic photoconductive drum for use in electrophotography

(75) Inventor: Michel F. Molaire, Rochester, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/936,411

(22) Filed: Sep. 8, 2004

(51) Int. Cl. G03G 5/14

(52) U.S. Cl. 430/131; 430/133

(57) ABSTRACT

In a process for manufacturing an organic photoconductive drum there is sequentially formed on an electrically-conductive substrate that includes a cylindrical support of known weight the following layers: an optional dry undercoat layer, a dry barrier layer, a dry charge-generation layer, and a dry charge-transport layer. Following the formation of each dry layer, the cumulative weights of the cylindrical support and the dry layer(s) sequentially formed on the support are determined. Using the cumulative weights, the weight of each dry layer is determined by subtraction. The thickness of each dry layer is then determined, using previously acquired data correlating weight with thickness for each dry layer.

### FIELD OF THE INVENTION

The present invention relates to electrophotography and, more particularly, to a process for manufacturing an organic photoconductive drum of high quality for use in an electrophotographic apparatus.

### BACKGROUND OF THE INVENTION

Photoconductive elements useful, for example, in electrophotographic copiers and printers are composed of a conducting support having a photoconductive layer that is insulating in the dark but becomes conductive upon exposure to actinic radiation. To form images, the surface of the element is electrostatically and uniformly charged in the dark and then exposed to a pattern of actinic radiation. In areas where the photoconductive layer is irradiated, mobile charge carriers are generated that migrate to the surface and dissipate the surface charge. This leaves in nonirradiated areas a charge pattern known as a latent electrostatic image. The latent image can be developed, either on the surface on which it is formed or on another surface to which it is transferred, by application of a liquid or dry developer containing finely divided charged toner particles.

Photoconductive elements can include single or multiple active layers. Those with multiple active layers, also referred to as multi-active elements, have at least one charge-generation layer (CGL) and at least one n-type or p-type charge-transport layer (CTL). Under actinic radiation, the charge-generation layer generates mobile charge carriers, and the charge-transport layer facilitates migration of the charge carriers to the surface of the element, where they dissipate the uniform electrostatic charge and form the latent electrostatic image. Photoconductive elements and their preparation and use are well known and are discussed in, for example, U.S. Pat. Nos. 4,971,873, 5,128,226, 5,681,677, and 6,294,301, the disclosures of which are incorporated herein by reference.

Also useful in photoconductive elements are charge barrier layers, which are formed between the conductive layer and the charge generation layer to restrict undesired injection of charge carriers from the conductive layer. Various polymers are known for use in barrier layers of photoconductive elements, as described in, for example, the previously cited U.S. Pat. Nos. 4,971,873, 5,128,226, 5,681,677, and 6,294,301.

The CGL, CTL, barrier layer, and other layers of a photoconductive element are coated on an “electrically-conductive substrate,” by which is meant either a substrate that is electrically-conductive itself, for example, one formed from a metal such as nickel or aluminum, or a substrate that comprises a non-conductive polymeric support material substrate on which is coated a conductive layer, such as vacuum deposited or electroplated nickel. Photoconductive substrates can be fabricated in a variety of shapes, for example, as a sheet, a drum, or an endless belt. The process of the present invention, however, is directed to the manufacture of a photoconductor having a cylindrical, drum-shaped substrate. The preparation of a photoconductive drum and the use of a laser to reduce the thickness of the polymeric photoconductive layer is described in U.S. Pat. No. 5,418,349, the disclosure of which is incorporated herein by reference.

### SUMMARY OF THE INVENTION

The present invention is directed to a process for manufacturing an organic photoconductive drum that includes: sequentially forming on an electrically-conductive substrate including a cylindrical support having a predetermined weight an optional dry undercoat layer, a dry barrier layer, a dry charge-generation layer, and a dry charge-transport layer; following the formation of each dry layer, determining the cumulative weights of the cylindrical support and the dry layer(s) sequentially formed on the support; using the cumulative weights, determining by subtraction the weight of each dry layer; and, using previously acquired data correlating weight with thickness for each dry layer, determining the thickness of each dry layer.

### BRIEF DESCRIPTION OF THE DRAWINGS

FIG. 1 is a schematic representation of an organic photoconductive drum prepared by the manufacturing process of the present invention.

FIG. 2 is a block diagram depicting the steps of the process of the invention.

### DETAILED DESCRIPTION OF THE INVENTION

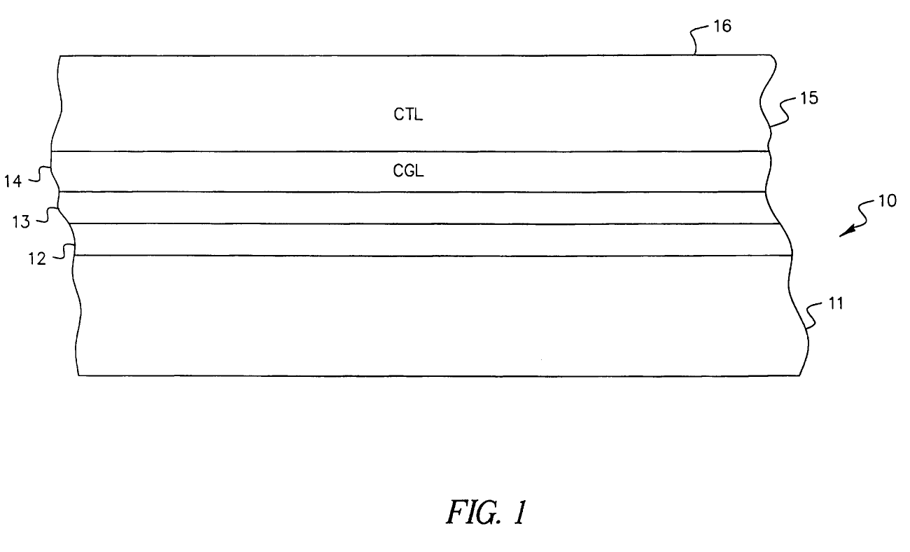

As illustrated in FIG. 1, a photoconductive drum 10 includes a cylindrical support 11, over which is formed an optional undercoat layer (UL) 12. A polymeric barrier layer (BL) 13 is formed over layer 12, and sequentially formed over layer 13 are a charge generation layer (CGL) 14 and a p-type charge transport layer (CTL) 15. Positive charge carriers generated by CGL 14 and transported by CTL 15 dissipate negative charges on the surface 16 of photoconductive drum 10. Alternatively, the CTL 15 can be n-type, in which case negative charge carriers generated by CGL 14 are transported by CTL 15 to dissipate positive charges on surface 16.

Cylindrical support 11 preferably includes a conductive metallic material such as nickel or aluminum, more preferably, nickel. When support 11 has a conductive material, the optional undercoat layer 12 is a smoothing layer that preferably comprises a polymeric dispersion of a conductive metal oxide selected from the group consisting of aluminum oxide, titanium dioxide, tin oxide, copper oxide, palladium oxide, and indium oxide. Tin oxide and titanium dioxide are preferred.

Alternatively, cylindrical support 11 can be formed from a non-conductive polymer such as polyethylene terephthalate, in which case undercoat layer 12 is required to be conductive, preferably including vacuum deposited or electroplated nickel. In this situation, non-conductive cylindrical support 11 and conductive undercoat layer 12 together form an electroconductive substrate for photoconductive drum 10.

Although other coating techniques can be employed, an automated dip coating process is the preferred method for manufacturing high quality organic photoconductive drums, which require the application to a cylindrical substrate of several layers having precisely controlled thicknesses. For example, light absorption by the light-sensitive CGL is very sensitive to its thickness, which is preferably about 0.25 μm to about 1.0 μm, more preferably, about 0.25 μm to about 0.5 μm. The charge blocking barrier layer (BL), which controls the chargeability of the photoconductor as well as the formation of white or black spots, has a thickness of preferably about 1 μm to about 3 μm, more preferably, about 0.25 μm to about 1.0 μm. The CTL has a thickness of preferably about 10 μm to about 30 μm, more preferably, about 15 μm to about 25 μm. The UL has a thickness of preferably about 0.5 μm to about 10 μm, more preferably, about 1 μm to about 5 μm.

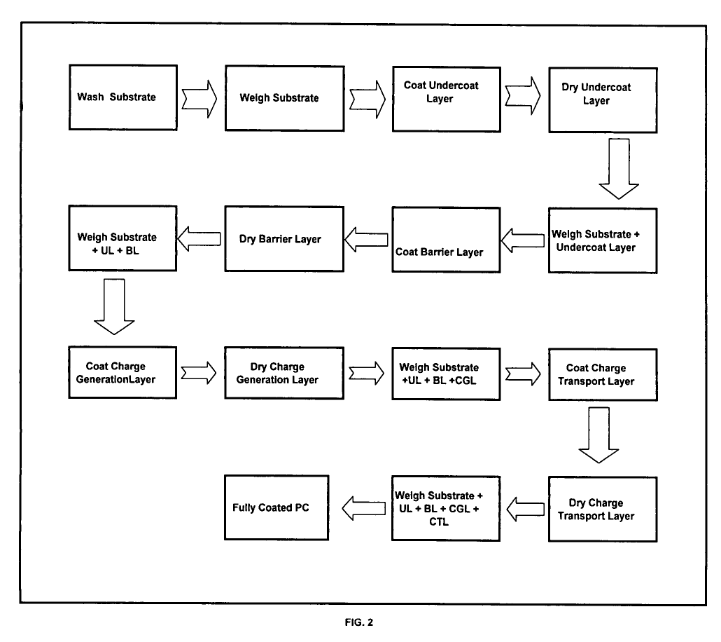

As shown in FIG. 2, a block diagram depicting the steps of the process of the present invention, an optional undercoat layer (UL), a barrier layer (BL), a charge-generation layer (CGL), and a charge-transport layer (CTL) are sequentially formed on a substrate of known weight by a series of coating and drying operations.

Automated dip coating is usually carried out in a class 100 environment to keep out dust particles. The above-mentioned layers are sequentially formed on the cleaned, dried, and weighed substrate. Drying of each coated layer is accomplished by heating in an oven at a drying station conveyor oven before the next layer is coated downstream. Precision balances installed after each drying station in the coating apparatus are employed to measure the following cumulative weights of the substrate and dried layer(s):

the dry weight of the substrate coated with the UL

the dry weight of the substrate coated with the UL and BL

the dry weight of the substrate coated with the UL, BL, and CGL

the dry weight of the substrate coated with the UL, BL, CGL, and CTL.

Typical solvents for solvent coating a photoconductive CGL over a BL are disclosed, for example, in the previously mentioned U.S. Pat. No. 5,681,677 and in U.S. Pat. No. 5,733,695, the disclosure of which is incorporated herein by reference. As these references indicate, the photoconductive material, e.g., a photoconductive pigment is solvent coated by dispersing it in a binder polymer solution. Commonly used solvents for this purpose include chlorinated hydrocarbons such as dichloromethane as well as ketones and tetrahydrofuran.

Because of the curvature of a photoconductor drum substrate, optical density measurements to determine the thickness of layers coated thereon are difficult. Ascertaining the thickness of such layers typically entails destroying a sample to make the necessary measurements, and then assuming that the layers on other drums coated around the same time have approximately that same thickness. The present invention, by contrast, provides weight measurements corresponding to dry layer thicknesses following each coating-drying sequence of the manufacturing process, enabling coating conditions to be adjusted to maintain the dried coated layers within specifications.

The weight measurement data are fed to a central controlling computer that contains previously determined data correlating weight with thickness for each dry layer and is programmed to calculate the coating thickness corresponding to the weight determined for each dry coated layer of each photoconductive drum. The resulting calculations can be further employed in a closed feedback loop to correct for any deviations from layer thickness specifications, coating parameters being adjusted to maintain the required layer thicknesses.

The process of the present invention can be adapted, for example, to automated dip coating machines provided by various manufacturers, including Toray Engineering Co., Ltd. of Japan. A Toray dip coating apparatus provided with a chucking mechanism can be modified to allow coated photoconductor drum substrates emerging from an oven following the drying of a newly applied coating layer to be chucked and lifted from a transport pallet to a precision balance installed between a drying station and a following dip coating station, un-chucked for weighing, and re-chucked after weighing for transport to the next dip coating station.

The described weighing steps are carried out using balances installed after each coating-drying station. Following drying of the last coated layer, the completed fully coated photoconductor drums can be lifted off the pallet by an operator and placed on a balance for weighing before transfer to a storage area.

The invention has been described in detail with particular reference to certain preferred embodiments thereof, but it is understood that variations and modifications can be effected within the spirit and scope of the invention, which is defined by the following claims.

What is claimed is:

1. A process for manufacturing an organic photoconductive drum comprising:
sequentially forming on an electrically-conductive substrate comprising a cylindrical support having a predetermined weight an optional dry undercoat layer, a dry barrier layer, a dry charge-generation layer, and a dry charge-transport layer;
following said forming of each said dry layer, determining the cumulative weights of said cylindrical support and said dry layer(s) sequentially formed on said support;
using said cumulative weights, determining by subtraction the weight of each said dry layer; and
using previously acquired data correlating weight with thickness for each said dry layer, determining the thickness of each said dry layer.

2. The process of claim 1, wherein said forming each said dry layer comprises:
sequentially applying by dip coating a coating layer on said cylindrical support and any previously sequentially formed dry layer(s); and
drying said coating layer.

3. The process of claim 1, wherein said electrically-conductive substrate comprises a metal.

4. The process of claim 3, wherein said metal is selected from the group consisting of aluminum and nickel.

5. The process of claim 4, wherein said metal is nickel.

6. The process of claim 3, wherein said undercoat layer comprises a polymeric dispersion of a conductive metal oxide selected from the group consisting of aluminum oxide, titanium dioxide, tin oxide, copper oxide, palladium oxide, and indium oxide.

7. The process of claim 6, wherein said metal oxide is tin oxide.

8. The process of claim 6, wherein said metal oxide is titanium dioxide.

9. The process of claim 1, wherein said electrically-conductive substrate comprises a non-conductive cylindrical support and a conductive undercoat layer.

10. The process of claim 9, wherein said non-conductive cylindrical support comprises a polymer and said conductive undercoat layer comprises nickel.

11. The process of claim 1, wherein said undercoat layer has a thickness of about 0.5 μm to about 10 μm.

12. The process of claim 1 1, wherein said undercoat layer has a thickness of about 1 μm to about 5 μm.

13. The process of claim 1, wherein said barrier layer has a thickness of about 1 μm to about 3 μm.

14. The process of claim 13, wherein said barrier layer has a thickness of about 0.25 μm to about 1.0 μm.

15. The process of claim 1, wherein said charge-generation layer has a thickness of about 0.25 μm to about 1.0 μm.

16. The process of claim 15, wherein said charge-generation layer has a thickness of about 0.25 μm to about 0.5 μm.

17. The process of claim 1, wherein said charge-transport layer has a thickness of about 10 μm to about 30 μm.

18. The process of claim 17, wherein said charge-transport layer has a thickness of about 15 μm to about 25 μm.

19. The process of claim 1, wherein said determining the cumulative weights of said cylindrical support and said dry layer(s) is carried out using a precision balance.

20. The process of claim 1, wherein said previously acquired data correlating weight with thickness is stored in a central controlling computer.

21. The process of claim 1, wherein said previously acquired data correlating weight with thickness is employed in a closed feedback loop to correct for deviations from dry layer thickness specifications, coating parameters being adjusted to maintain said thickness specifications.
